(19) United States
(12) Patent Application Publication
(10) Pub. No.: US 2014/0208778 A1
(43) Pub. Date: Jul. 31, 2014

(54) Retrieval Apparatus and Methods of Use Thereof

(71) Applicants: Kenneth Raley, Pierce City, MO (US); Amy Raley, Pierce City, MO (US)

(72) Inventors: Kenneth Raley, Pierce City, MO (US); Amy Raley, Pierce City, MO (US)

(21) Appl. No.: 13/750,557

(22) Filed: Jan. 25, 2013

(51) Int. Cl. B65G 9/00; B65D 30/00

(52) U.S. Cl. CPC B65G 9/00; B65D 29/00
USPC 62/62; 294/173; 62/457.2; 383/14

(57) ABSTRACT

An apparatus for retrieving items from a cooler, said apparatus having a cord, a securing mechanism for receiving an item, and a buoy, where the buoy engages the cord, the cooler contains coolant for cooling the item, and the buoy allows for the cord to be obtained without reaching into the coolant.

### CROSS-REFERENCE TO RELATED APPLICATION

This application claims the benefit of priority to U.S. Provisional Application No. 61/632,525 filed on Jan. 25, 2012, which is incorporated herein by reference in its entirety.

### BACKGROUND

Ice chests or coolers are used to contain many types of items for example, without limitation, foodstuffs including meats, cheeses, produce, beverages, non-food items, or the like. The primary function of the cooler is to keep these items cold, using a coolant. When coolant is used as the cooling agent (either when initially filling the cooler with the items and coolant, or when refilling with coolant after the previous added coolant has melted), the items are usually covered with or submerged in the coolant. Difficulty arises when locating and retrieving the items without removing the coolant or reaching into the coolant.

### SUMMARY OF THE INVENTION

The present disclosure pertains to an apparatus for retrieving items from a cooler, said apparatus having a cord, a securing mechanism for receiving an item, and a buoy, where the buoy engages the cord, the cooler contains coolant for cooling the item, and the buoy allows for the cord to be obtained without reaching into the coolant. In one aspect of the disclosure, the securing mechanism has a loop. In another aspect of the disclosure, the securing mechanism has a loop adjusting mechanism. In another aspect of the disclosure, the securing mechanism has a bag having a flexible sidewall. In another aspect of the disclosure, the securing mechanism has a drawstring assembly having a cord and a bag mechanism. In another aspect of the disclosure, the bag has a top passageway for receiving the cord. In another aspect of the disclosure, the bag has a sidewall passageway for allowing coolant to enter and exit the bag. In another aspect of the disclosure, the bag is made of mesh material for allowing coolant to enter and exit the bag. In another aspect of the disclosure, the apparatus has a label.

Another aspect of the disclosure pertains to a retrieval system for retrieving items from a cooler having a retrieval apparatus, a cooler, and a fastening mechanism for receiving a retrieval apparatus, where the fastening mechanism engages the cooler. In another aspect of the disclosure, the fastening mechanism has a channel for receiving the cord, where the channel is incorporated into the cooler. In another aspect of the disclosure, the fastening mechanism has a hook for receiving the cord, where the hook engages the cooler. In another aspect of the disclosure, the hook has an eye and a hook gap for allowing the cord to enter the eye of the hook. In another aspect of the disclosure, the distance of the hook gap is less than the diameter of the cord. In another aspect of the disclosure, the fastening mechanism has a first member and second member for securing the retrieval apparatus to the cooler. In another aspect of the disclosure, the fastening mechanism has a hook and loop mechanism allowing for the first member to engage the second member. In another aspect of the disclosure, the fastening mechanism has an adhesive surface allowing for the fastening mechanism to engage the cooler.

Another aspect of the disclosure pertains to a method of retrieving an item from a cooler having the steps of: securing a retrieval apparatus to the cooler by way of the fastening mechanism, passing an item through or into the securing mechanism of the retrieval apparatus, adjusting the securing mechanism, thereby securing the loop to the item, adding coolant to a cavity of the cooler, disengaging the retrieval apparatus from the cooler, and allowing the buoy to rest on top of the surface of the coolant.

In another aspect of the disclosure, the method has the steps of: pulling the cord, thereby obtaining the item received by the securing mechanism, and opening the securing mechanism thereby allowing the item to be removed. In another aspect of the disclosure, the method has the step of writing the name of the item on a label, thereby identifying the item received by the retrieval apparatus.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of a retrieval system according to an exemplary embodiment.

FIG. 2 is a perspective view of a retrieval system according to an exemplary embodiment.

FIG. 3 is a side view of a retrieval apparatus according to an exemplary embodiment.

FIG. 4 is a side view of a retrieval apparatus according to an exemplary embodiment.

FIG. 5 is a perspective view of a retrieval system according to an exemplary embodiment.

FIG. 6 is a side view of a retrieval system according to an exemplary embodiment.

FIG. 7 is a perspective view of a fastening mechanism according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure pertains to an apparatus, system, and methods of retrieving an item 200, for example, without limitation, foodstuffs or beverages, from a cooler 300. In one embodiment, a retrieval apparatus 100 allows the item 200 to be retrieved without requiring the hand of the user to touch or be submerged in the coolant 310 of the cooler 300.

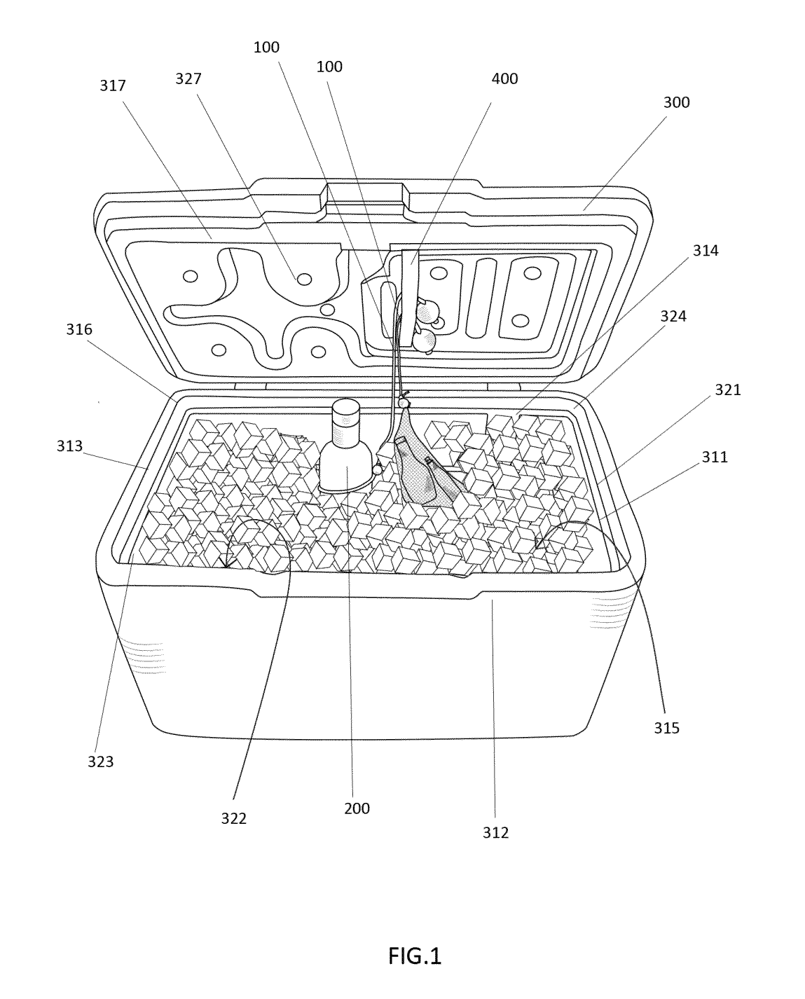

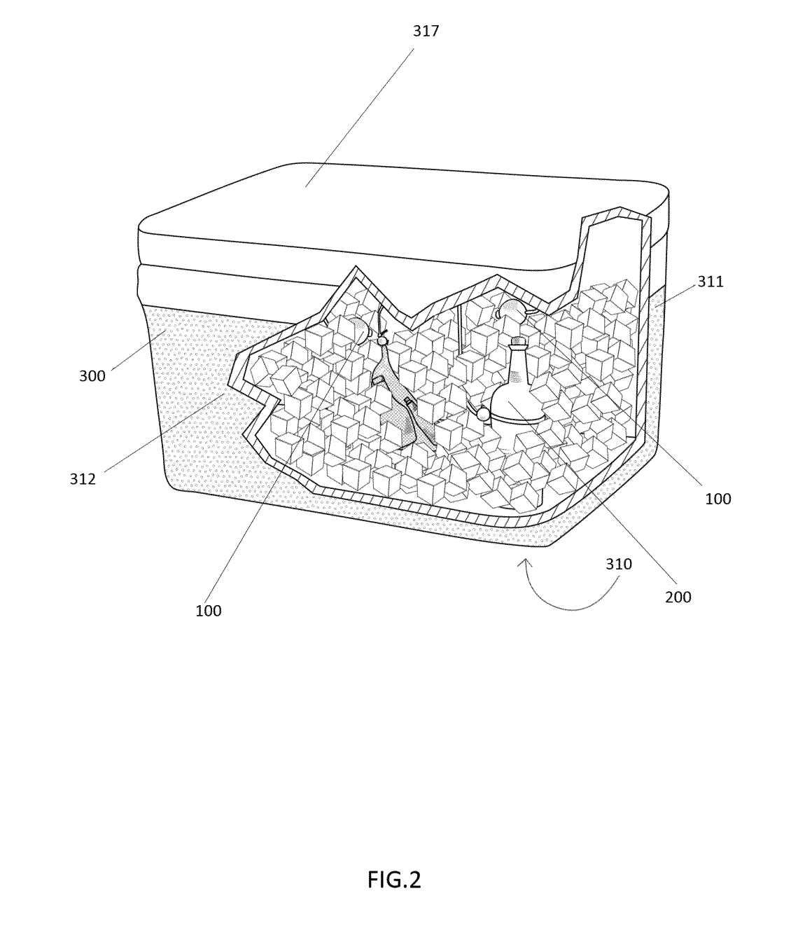

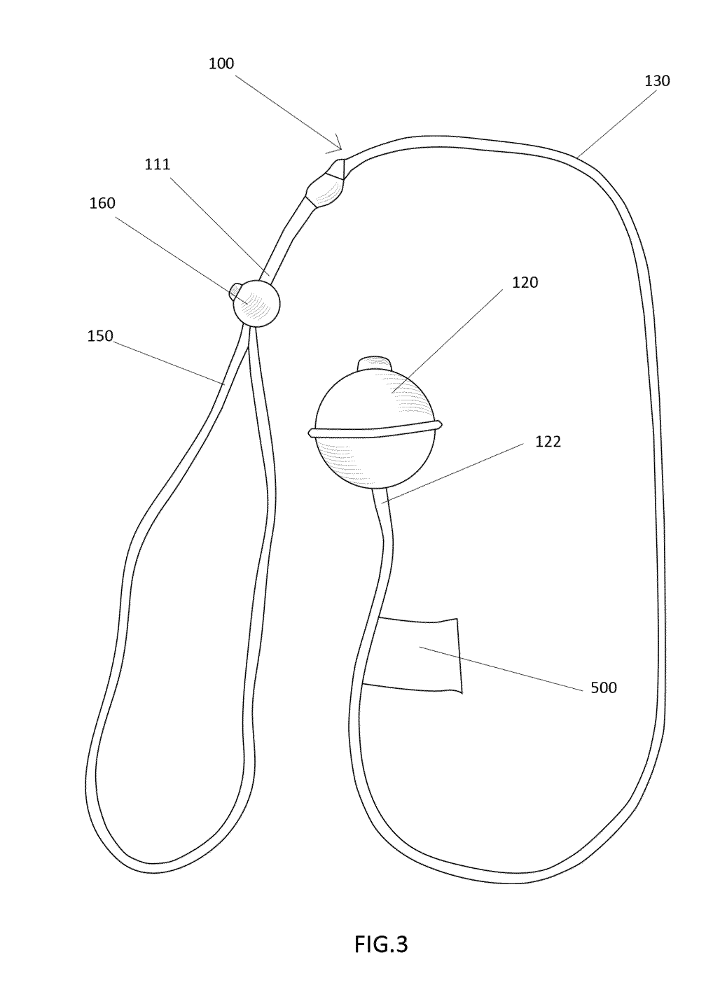

In one embodiment, the retrieval apparatus 100 is placed in a cooler 300 having coolant 310, for cooling and maintaining items 200, placed therein. As shown in FIGS. 1-3, cooler 300 can have a base 310 bound and defined by sidewalls 311, 312, 313, 314 which extend upwardly therefrom having interior surfaces 321, 322, 323, 324, thereby forming a cavity 315 with a rim 316. The cooler 300 can have a removable or releasable cover 317 having an interior surface 327, where the cover 317 is engaged to or incorporated into any sidewall 311, 312, 313, 314 which when removed or released, exposes a cooler opening 318 through which retrieval apparatus 100, items 200, and coolant 310 can be placed within cavity 315.

Coolant 310 is typically a frozen liquid, such as water frozen into ice, but may consist of other materials or substances typically used for cooling. Coolant 310 absorbs heat from items 200 thereby cooling the items 200 and maintaining them at a cool temperature. When coolant 310 is a frozen, coolant 310 will melt into a liquid, resulting in the presence of liquid in the interior of the cooler 300. Cooling of items 200 with coolant 310 may cause condensation of additional liquid, such as water, from air in proximity to the items 200.

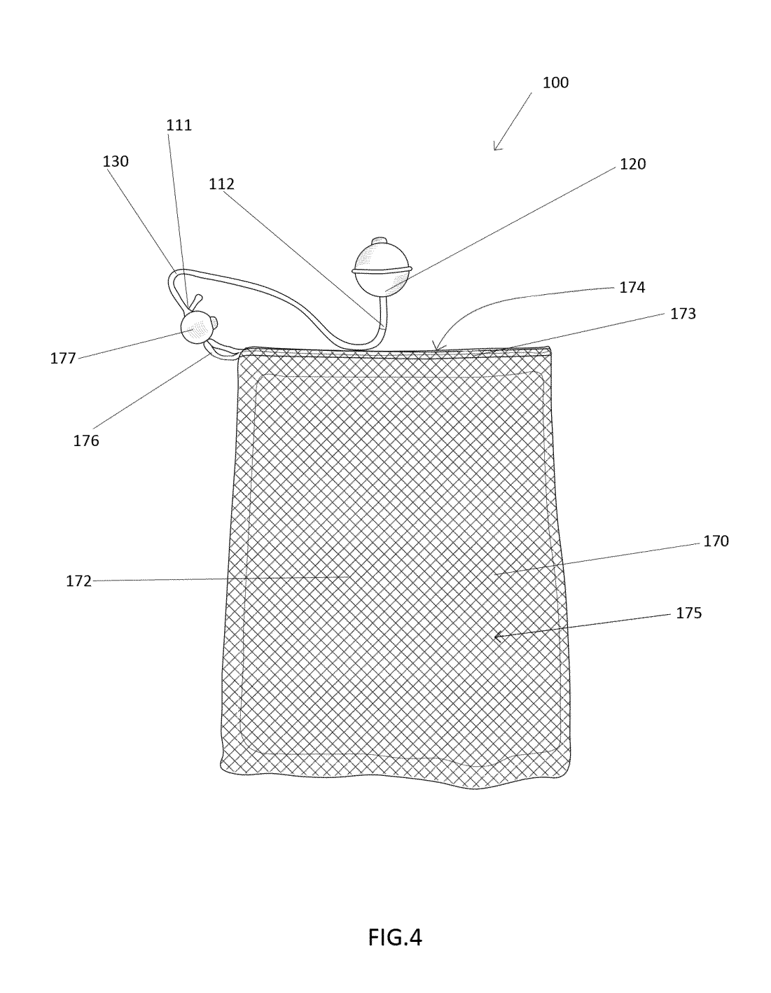

In one embodiment, as shown in FIG. 4, the retrieval apparatus 100 can have at least one securing mechanism 110, a buoy 120, and a cord 130. The securing mechanism 110 can be any mechanism allowing for the retrieval apparatus 100 to engage, capture, receive, or connect to an item 200. The securing mechanism 110 engages a first end 111 of the elongated cord 130. In one embodiment, as shown in FIG. ______, the securing mechanism 110 can have a loop 150 where the loop 150 receives an item 200. For example, the loop 150 can receive a bottle where the bottle passes through the loop 150 thereby securing the retrieval apparatus 100 to the bottle. The loop 150 can be positioned on any location of the item 200, for example, the neck, handle, body, or the like.

While the loop 150 can be non-adjustable, the securing mechanism 110 can have a loop mechanism 160 for adjusting the diameter of the loop 150. For example, the loop mechanism 160 allows for the length of the diameter of the loop 150 to increase or decrease. The loop mechanism 160 can be any device used to adjust the length of the diameter of a loop 150 in a strap, cord, or the like, for example, a cord stop, fastener, buckle, or the like, where the first end 111 of the cord 130 passes through a central bore which is formed in a closure member. To decrease or increase the length of the diameter of the loop 150, an inward pressure on a spherical member housed within the closure member, along with a force exerted on the loop 150, the direction of the force corresponding to the desired diameter of the loop 150, will allow for the diameter of the loop 150 to be increased or decreased.

In one embodiment, the retrieval apparatus 100 has a plurality of securing mechanisms 110. Where the plurality of securing mechanism 110 are loops 150, the loops 150 are in-line with the elongated cord 130, where the elongated cord 130 is used to create a plurality of loops 150. The loops 150 can be any combination of adjustable or non-adjustable loops 150, where each adjustable loop 150 can have a loop mechanism 160.

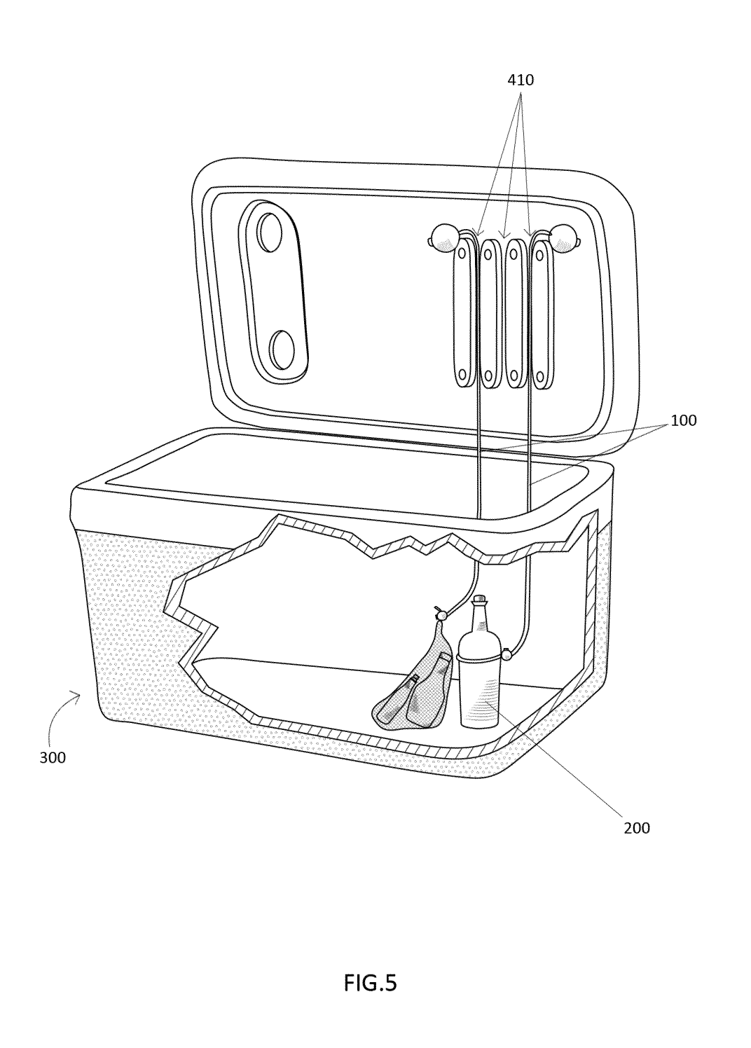

In one embodiment, as shown in FIG. 5, the securing mechanism 110 can have a bag 170 for receiving at least one item 200. The bag 170 can have a collapsible body having a flexible sidewall 172 and a top passageway 173 forming top opening 174. The collapsible body and flexible sidewall 172 can have a plurality of sidewall passageways 175 or be made of mesh material for allowing coolant 310 to enter and exit the bag 170.

In one embodiment, the securing mechanism 100 can have a drawstring assembly 176 for opening and closing the top opening 174 of the bag 170, thereby preventing accidental escape of the items 200 from the bag 170 when in the top opening 174 is in the closed position. The drawstring assembly 176 can have an elongated cord or strap which is threadably receivable within top passageway 173 and a bag mechanism 177 similar to the form and function of the loop mechanism 160 described herein.

The cord 130 allows for the securing mechanism 110 to be engaged to the buoy 120. The cord 130 is preferably elongated. The elongated cord 130 can have a first end 111 and a second end 112. The elongated cord 130 can be any length that allows for the buoy 120 to rest or float on the surface of the coolant 310. The elongated cord 130 can be made of any material for engaging the securing mechanism 110 to the buoy 120, for example, nylon, polyester, polyester, plastic, metal, any combination thereof, or the like.

The buoy 120 allows for the elongated cord 130 to be obtained without reaching into the coolant 310. The buoy 120 engages the second end 312 of the elongated cord 130 allowing for the second end 312 of the elongated cord 130 to remain above the surface of the coolant 310. The buoy 120 allows for the second end 312 of the elongated cord 130 to remain above the surface of the coolant 310 regardless of the phase of the coolant 310, for example, without limitation, ice, water, and all transition phases between ice and water. The buoy 120 can be made of any buoyant material, for example, without limitation, plastic, foam, cork, wood, neoprene, or the like. The buoy 120 can be any size or shape that allows for the buoy 120 to remain above the surface of the coolant 310. In one embodiment, the buoy 120 has a label surface allowing for the name of at least one item 200 to be written on the label surface thereby identifying the item 200 captured by the retrieval apparatus 100. In one embodiment, the buoy 120 slideably engages the elongated cord 130 thereby allowing for buoy 120 to traverse the elongated cord 130. For example, the buoy 120 can traverse the elongated cord 130 thereby being positioned at a location on the elongated cord 130 where the length of the elongated cord 130 between the buoy 120 and the loop 150 is substantially similar or corresponds to the depth of the coolant 310.

In one embodiment, the retrieval apparatus 100 has a label 500 where the name of at least one item 200 is written on the label 500 thereby identifying the item 200 captured by the retrieval apparatus 100.

In one embodiment, a retrieval system has a retrieval apparatus 100, cooler 300, and fastening mechanism 400. The retrieval system can have at least one fastening mechanism 400 for receiving a retrieval apparatus 100 and/or coupling at least one retrieval apparatus 100 to the cooler 300. In one embodiment, the fastening mechanism 400 allows for the elongated cords 130 to be located at a known position thereby avoiding the need to search the cooler 300 for the elongated cord 130 and/or preventing the elongated cords 130 from becoming tangled or snarled. Where the cooler 300 has a plurality of fastening mechanism 400, the fastening mechanism 400 can be located in close proximity or spread out within the cooler 300. The fastening mechanism 400 can be located on any interior surface of the cooler 300 including the interior surfaces 321, 322, 323, 324 of a sidewall 311, 312, 313, 314 and the interior surface 327 of the cover 317. The fastening mechanism 400 can engage an interior surface 321, 322, 323, 324 of the cooler 300 by way of an adhesive surface 412, for example, glue, tape, or the like, hardware, screws, or the like.

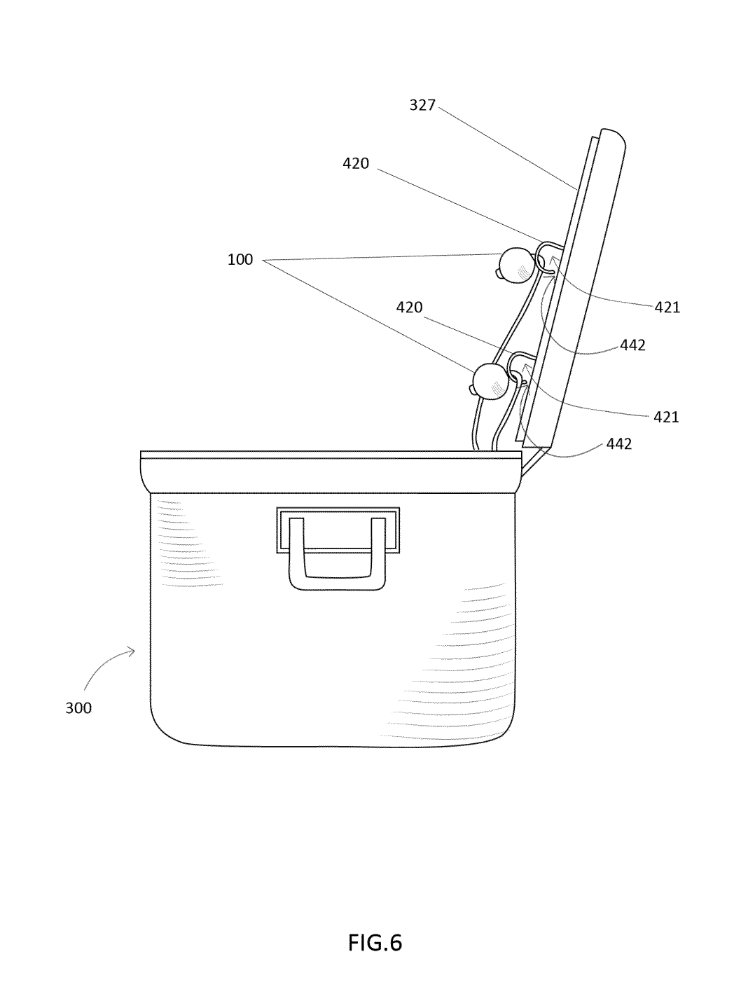

In one embodiment, as shown in FIG. 6, the fastening mechanism 400 can have an elongated channel 410 incorporated into the interior surface of the cooler 300 for receiving the elongated cord 130. The diameter of the elongated channel 410 is slightly less than the diameter of the elongated cord 130 where, upon receiving the elongated cord 130, the elongated channel 410 pinches the elongated cord 130 thereby securing the elongated cord 130 to the cooler 300. The length of the elongated cord 130 can be any length that allows for the buoy 120 to be coupled to an item 200 thereby allowing for the buoy 120 to rest or float on the surface of the coolant 310.

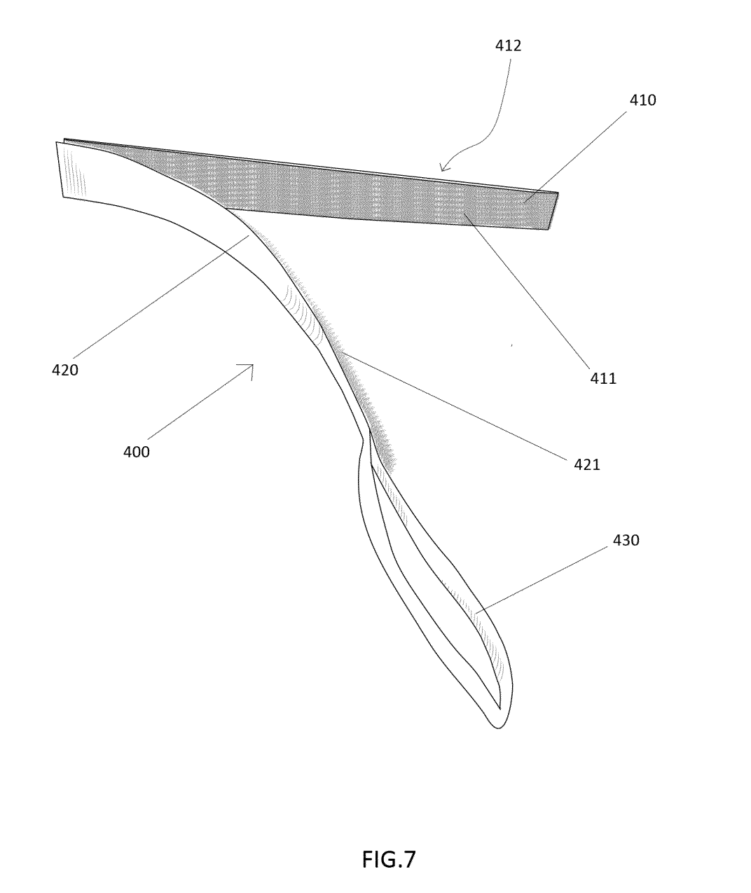

In one embodiment, as shown in FIG. 7, the fastening mechanism 400 can have a hook 420 that engages an interior surface of the cooler 300 for coupling the retrieval apparatus 100 to the interior of the cooler 300. The hook 420 has an eye 421 and a hook gap 422 located between the end of the hook 420 and an interior surface of the cooler 300. The hook gap 442 allow for the cord 130 to enter the eye 421 of the hook 420. The distance of the hook gap 422 can be less than the diameter of the cord 130 thereby requiring a substantial force to be applied to the cord 130 when passing the cord 130 through the hook gap 422. The absence of a substantially similar force prevents the cord 130 from exiting the hook 420 by passing through the hook gap 422. In one embodiment, the diameter of the buoy 120 is greater than the diameter of the hook 420 thereby preventing the buoy 120 and thus the complete length of the cord 130 from passing through the eye 421 of the hook 420.

In one embodiment, as shown in FIG. 8, the fastening mechanism 400 can have a first member 410 and second member 420 for securing the retrieval apparatus 100 to the cooler 300. The fastening mechanism 400 can have a hook and loop mechanism or the like allowing the first member 410 to engage the second member 420. For example, the interior surface 411 of the first member 410 can have hook and the interior surface 421 of the second member 420 can have loop. The cord 130 is then coupled to the interior surface 321, 322, 323, 324 of the cooler 300 by way of the fastening mechanism 400 where the cord 130 is placed between the first member 410 and the second member 420, and the hook and loop of the first member 410 and second member 420 are allowed to engage, thereby pinching the cord 130 between the first member 410 and second member 420. In one embodiment, the fastening mechanism 400 can have a handle 430 allowing for the first member 410 to be separated from the second member 420.

The following describes a method of retrieving an item 200 from a cooler 300. In one embodiment, the method has the step of securing the elongated cord 130 to the cooler 300 by way of the fastening mechanism 400, thereby preventing the cord 130 from being submerged upon the addition of the coolant 310. In one embodiment, the item 200 is passed through the loop 150 and the loop 150 is adjusted thereby securing the loop 150 to the item 200. In one embodiment, at least one item 200 is placed into a bag 170 and the drawstring is pulled thereby closing the top opening 174 of the bag 170. In one embodiment, the name of the item 200 is written on a label 500 thereby identifying the item 200 captured by the retrieval apparatus 100. The coolant 310 can be added to the cavity 315 of the cooler 300. The item 200 is submerged in the coolant 310 of the cooler 300 and the buoy 120 is allowed to rest or float on top of the surface of the coolant 310 allowing for the buoy 120 and thus the elongated cord 130 to be retrieved in the future. In one embodiment, the fastening mechanism 400 secures the second end 312 of the cord 130 to the cooler 300, thereby securing the cord 130 above the surface of the coolant 310. To access an item 200, the elongated cord 130 is pulled, thereby allowing the item 200 captured by the securing mechanism 110 to be obtained. The diameter of the loop 150 or top opening 174 of the bag 170 is increased thereby allowing the item 200 to be removed from the securing mechanism 110.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items 200.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. An apparatus for retrieving items from a cooler, said apparatus comprising:
a cord,
a securing mechanism for receiving an item, and
a buoy,
whereby the buoy engages the cord, the cooler contains coolant for cooling the item, and the buoy allows for the cord to be obtained without reaching into the coolant.

2. The apparatus of claim 1 wherein the securing mechanism comprises a loop.

3. The apparatus of claim 2 wherein the securing mechanism further comprises a loop adjusting mechanism.

4. The apparatus of claim 1 wherein the securing mechanism comprises a bag having a flexible sidewall.

5. The apparatus of claim 4 wherein the securing mechanism further comprises a drawstring assembly having a cord and a bag mechanism.

6. The apparatus of claim 5 wherein the bag comprises a top passageway for receiving the cord.

7. The apparatus of claim 4 wherein the bag further comprises a sidewall passageway for allowing coolant to enter and exit the bag.

8. The apparatus of claim 4 wherein the bag is made of mesh material for allowing coolant to enter and exit the bag.

9. The apparatus of claim 1 further comprising a label.

10. A retrieval system for retrieving items from a cooler comprising a retrieval apparatus of claim 1, a cooler, and a fastening mechanism for receiving a retrieval apparatus, whereby the fastening mechanism engages the cooler.

11. The system of claim 10 wherein the fastening mechanism comprises a channel for receiving the cord, where the channel is incorporated into the cooler.

12. The system of claim 10 wherein the fastening mechanism comprises a hook for receiving the cord, where the hook engages the cooler.

13. The system of claim 10 wherein the hook comprises an eye and a hook gap for allowing the cord to enter the eye of the hook.

14. The system of claim 13 wherein the distance of the hook gap is less than the diameter of the cord.

15. The system of claim 10 wherein the fastening mechanism comprises a first member and second member for securing the retrieval apparatus to the cooler.

16. The system of claim 10 wherein the fastening mechanism comprises a hook and loop mechanism allowing for the first member to engage the second member.

17. The system of claim 10 wherein the fastening mechanism comprises an adhesive surface allowing for the fastening mechanism to engage the cooler.

18. A method of retrieving an item from a cooler comprising the steps of:
securing a retrieval apparatus to the cooler by way of the fastening mechanism,
passing an item through or into the securing mechanism of the retrieval apparatus,
adjusting the securing mechanism, thereby securing the loop to the item,
adding coolant to a cavity of the cooler,
disengaging the retrieval apparatus from the cooler, and
allowing the buoy to rest on top of the surface of the coolant.

19. The method of claim 18 further comprising the steps of:
pulling the cord, thereby obtaining the item received by the securing mechanism, and opening the securing mechanism thereby allowing the item to be removed.

20. The method of claim 18 further comprising the step of writing the name of the item on a label, thereby identifying the item received by the retrieval apparatus.
